(19) United States
(12) Patent Application Publication
(10) Pub. No.: US 2017/0336212 A1
(43) Pub. Date: Nov. 23, 2017

(54) METHODS, APPARATUSES AND SYSTEMS FOR INDOOR NAVIGATION

(71) Applicant: Alibaba Group Holding Limited, Grand Cayman (KY)

(72) Inventors: Gang ZHAO, Hangzhou (CN); Zefang WANG, Hangzhou (CN); He WANG, Hangzhou (CN); Dufu LIU, Hangzhou (CN)

(21) Appl. No.: 15/597,649

(22) Filed: May 17, 2017

(30) Foreign Application Priority Data
May 19, 2016 (CN) 201610334482.3

(51) Int. Cl. G01C 21/20; H04W 4/04

(52) U.S. Cl. CPC G01C 21/206; H04W 4/04

(57) ABSTRACT

The disclosure describes methods, apparatuses and systems for indoor navigation. In one embodiment, a method is disclosed which comprises receiving a current location of a moving object at a current building level and a destination location at a destination building level; transmitting the current location and the destination location to a back-end device; receiving information of available cross-level tools and routes to the destination location from the back-end device, wherein the available cross-level tools comprise a plurality of available cross-level tools at the current building level, and the routes to the destination location include one or more direct or indirect routes to the destination location using the available cross-level tools; and displaying the available cross-level tools and the routes to the destination location.

### CROSS-REFERENCE TO RELATED APPLICATIONS

This application claims the benefit of priority of Chinese Application No. 201610334482.3, titled “Method, Apparatus and System for Indoor Navigation,” filed on May 19, 2016, which is hereby incorporated by reference in its entirety.

### BACKGROUND

### Technical Field

The following disclosure relates to the field of Internet technology, and in particular to a method, apparatus and system for providing indoor navigation.

### Description of the Related Art

Due to the large area and high density of shops in a large shopping mall, customers often feel lost and are unable to arrive at their destinations in a timely fashion. An information guideboard for building levels is usually provided at the entrance of a shopping mall and displays store locations on each building level. Based on this guideboard, customers can plan routes to their destinations. However, guideboards simply provide static building level information. Therefore, customers need to come up with feasible routes based on their own planning, which is not convenient or consistent in practice.

To solve this problem, embodiments of an indoor navigation solution are disclosed herein. Similar to conventional outdoor navigation technology, indoor navigation automatically plans a route according to a customer's departure point location (e.g., a current location) and a destination location (e.g., a bathroom or certain store) by taking the structural layout of a shopping mall and guiding the customer's movement with the aid of such navigation technology. Customers only need to walk in accordance with the guided directions of the routes shown on their mobile phones and do not need to fully understand the structural layout of each building level, making the indoor navigation a convenient and easy-to-use technology.

In contrast with an outdoor navigation technology, the environment in which the indoor navigation technology is applied has its own unique characteristics. In general, outdoor navigation is mainly utilized in environments such as roads and streets. That is, outdoor navigation only needs to plan planar routes based on a two-dimensional map. Most indoor environments, however, are three-dimensional spaces, such as multi-story buildings. Because the indoor space is three-dimensional, vertical routes that go through different building levels also need to be accounted for in addition to the planar routes through each building level. It is therefore necessary to pay attention to the various ways of moving between lower and higher floors when planning a passage route in a three-dimensional space.

Current indoor navigation solutions, by convention, only plan one fixed route. For example, when customers need to get to the fourth level of a building from the first level of a building, the planned route can be as follows:

(1) take the elevator located at the lower level of the building to the third level of the building;

(2) turn left out of the elevator, continue straight for 50 meters; and

(3) take the escalator to arrive at the fourth level of the building.

In actual practice, more than one “cross-level tool” (e.g., elevators, escalators, and staircases) for moving between lower and higher floors exists in large buildings, such as shopping malls. Moreover, the number and location of cross-level tools may also vary. At the same time, different cross-level tools may be used for different purposes. Take escalators as an example. Escalators may come as one-level escalators that connect adjacent building levels, and cross-level escalators that cross multiple building levels. Likewise, elevators may stop at each building level, or they can only stop at a subset of the levels of a building (e.g., an “express” elevator stopping at only a few, select levels). When multiple building levels exist between a customer's departure point and the destination, the customer will face various new passageways when arriving at their destination level.

It is thus clear that the routes between the departure point and the destination point are gathered based on the passageways of each building level. The more building levels that exist between the departure point and the destination, the larger the number of the generated routes will be, and the routes are generated based on the arrangement and combination of the passageways between each building level. The solution provided by existing indoor navigation systems is oversimplified, leaving customers no choices regarding cross-level routes, and is therefore flexible in use.

### BRIEF SUMMARY

The disclosure provides a method, apparatus, and system for indoor navigation that solves the problems of current solutions that only provide a single navigational route and lack flexibility as discussed above.

In one embodiment, a method is disclosed which comprises receiving a current location of a moving object at a current building level and a destination location at a destination building level; transmitting the current location and the destination location to a back-end device; receiving information of available cross-level tools and routes to the destination location from the back-end device, wherein the available cross-level tools comprise a plurality of available cross-level tools at the current building level, and the routes to the destination location include one or more direct or indirect routes to the destination location using the available cross-level tools; and displaying the available cross-level tools and the routes to the destination location.

In another embodiment, an apparatus is disclosed which includes one or more processors; and a non-transitory memory storing computer-executable instructions therein that, when executed by the processor, cause the apparatus to perform the operations of receiving a current location of a moving object at a current building level and a destination location at a destination building level; transmitting the current location and the destination location to a back-end device; receiving information of available cross-level tools and routes to the destination location from the back-end device, wherein the available cross-level tools comprise a plurality of available cross-level tools at the current building level, and the routes to the destination location include one or more direct or indirect routes to the destination location using the available cross-level tools; and displaying the available cross-level tools and the routes to the destination location.

In another embodiment, a system is disclosed that includes a front-end device for receiving a current location of a moving object at a current building level and a destination location at a destination building level, receiving information of available cross-level tools and routes to the destination location, wherein the available cross-level tools comprise a plurality of available cross-level tools at the current building level, and the routes to the destination location include one or more direct or indirect routes to the destination location using the available cross-level tools, and displaying the available cross-level tools and the routes to the destination location. The system further includes a back-end device for receiving the current location and the destination location from the front-end device, identifying information of available cross-level tools and routes to the destination location, and transmitting information of available cross-level tools and routes to the destination location to the front-end device.

According to embodiments of methods, apparatuses, and systems for indoor navigation provided by the disclosure, a front-end device displays a plurality of available cross-level tools of the building level where a moving object is located and the corresponding routes to the destinations, offering the moving object options to choose. According to the disclosure, when a moving object moves among different levels, like going up and down the stairs, one can fully use the options of various feasible passage routes gathered based on the arrangements and combinations of the different cross-level tools of each building level. Compared with the one and only fixed route recommended using current techniques, the disclosure provides expanded selections of passage routes and improves indoor navigation flexibility, thereby assisting the customers to arrive at their destinations in a faster manner.

The above illustration is merely an overview of the technical solution of the disclosure. To make the technical means of the disclosure clearer, the disclosure can be implemented according to the detailed description; further, to make the above and other purposes, characteristics, and advantages of the disclosure easy to understand, specific implementations of the disclosure are enumerated as follows.

### BRIEF DESCRIPTION OF THE DRAWINGS

By reading through the detailed description of the embodiments below, a person skilled in the art will be able to understand other advantages and benefits. Figures are only used for illustrating some embodiments, which shall not be considered as limitations to the disclosure. The same reference symbols are used for representing the same parts in the figures.

FIG. 1 illustrates a first indoor navigation diagram according to some embodiments of the disclosure.

FIG. 2 is a flow diagram illustrating a method for indoor navigation according to some embodiments of the disclosure.

FIG. 3 illustrates a second indoor navigation diagram according to some embodiments of the disclosure.

FIG. 4 illustrates a third indoor navigation diagram according to some embodiments of the disclosure.

FIG. 5 is a flow diagram illustrating a method for indoor navigation according to some embodiments of the disclosure.

FIG. 6 is a flow diagram illustrating a method for indoor navigation according to some embodiments of the disclosure.

FIG. 7 illustrates a fourth indoor navigation diagram according to some embodiments of the disclosure.

FIG. 8 illustrates a fifth indoor navigation diagram according to some embodiments of the disclosure.

FIG. 9 illustrates a sixth indoor navigation diagram according to some embodiments of the disclosure.

FIG. 10 is a block diagram illustrating an apparatus for indoor navigation according to some embodiments of the disclosure.

FIG. 11 is a block diagram illustrating an apparatus for indoor navigation according to some embodiments of the disclosure.

FIG. 12 is a block diagram illustrating an apparatus for indoor navigation according to some embodiments of the disclosure.

FIG. 13 is a schematic diagram of a system for indoor navigation according to some embodiments of the disclosure.

### DETAILED DESCRIPTION

The illustrative embodiments of the disclosure will be provided in more detail below with references to the figures. Although some embodiments provided by the disclosure are displayed in the figures, it should be understood that the disclosure can be implemented in numerous embodiments and is not limited by the embodiments described herein. Instead, these embodiments are provided to facilitate a better understanding of the disclosure, and to present a complete scope of the disclosure to a person skilled in the art.

The indoor navigation method provided by embodiments of the disclosure can be achieved by the collaboration of a front-end device and a back-end device. The front-end device is at least equipped with an input/output function, used for the human-computer interaction made with the moving object. The front-end device has a data reception and transmission function for interacting with the back-end device. The back-end device stores data related to indoor navigation, such as data relating to building level structures, configuration data for indoor cross-level tools, and the attributes of moving objects. In practical application, both the front-end device and the back-end device may be located in electronic devices such as a mobile phone, a tablet PC, and a wearable device. Alternatively, the front-end device may be located in an electronic device whereas the back-end device is located at a network location (e.g. a website server). While the former method achieves the goal of an offline mode of indoor navigation, the latter makes it possible for an online mode of indoor navigation.

For ease of understanding, before details of the various embodiments are provided, the longitudinal section of the schematic diagram of the building level used in describing the embodiments is presented first. The content of the schematic diagram of a building level is only used as an example and does not impose any limitation on the actual applications of the disclosure.

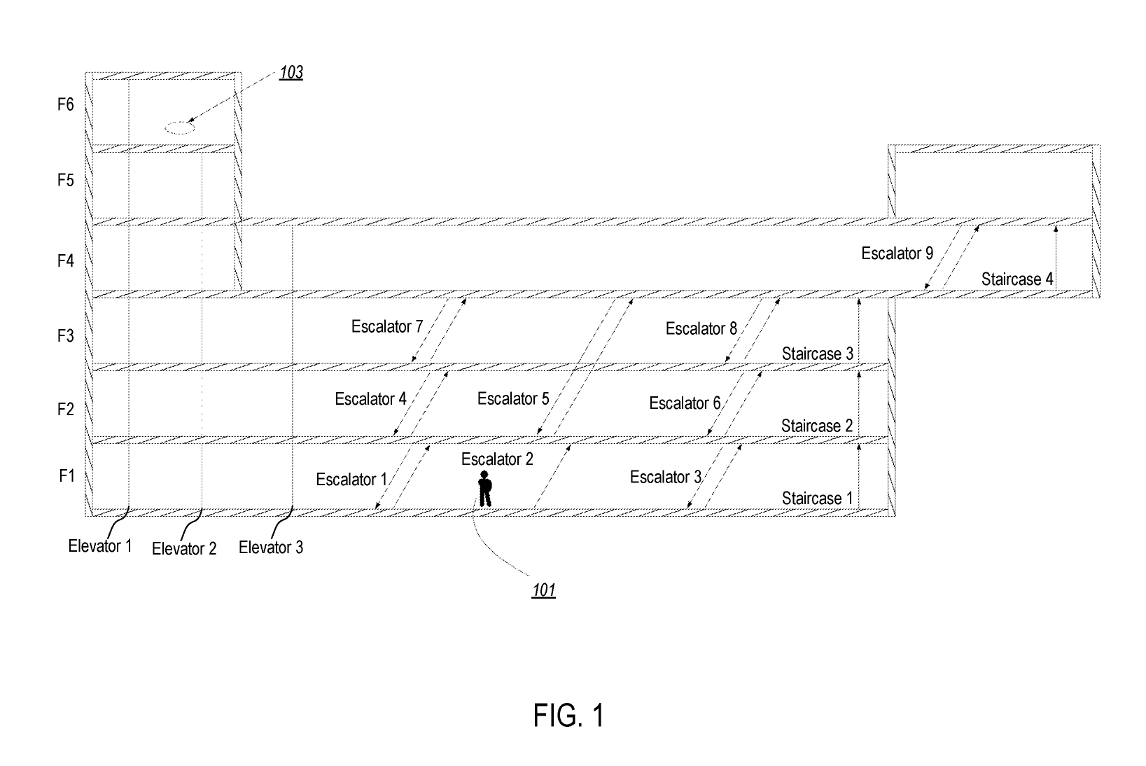

FIG. 1 illustrates a first indoor navigation diagram showing the longitudinal section of a six-level structure according to some embodiments of the disclosure.

The thickened oblique lines indicate the walls that a moving object cannot pass through; at the left side of the building body are three Elevators 1, 2, and 3, wherein Elevator 1 stops at every level (F1, F2, F3, F4, F5, F6), Elevator 2 only stops at three levels (F1, F3, and F5), and Elevator 3 only stops at four levels (F1, F2, F3, F4). In the middle section of each level of the building body are several Escalators 1-9. Escalator 5 is a cross-level escalator extending from the second level to the fourth level, while the rest of the Escalators are all one-level escalators. Further, Escalator 2 is a one-way escalator (e.g., from F1 to F2). Staircases 1-3 are provided between adjacent floors at the left side of the building body. The human-shaped icon shown in this figure indicates the current location of a moving object (101) at a current building level, i.e., the departure point; the dashed circular icon indicates the location (103) of the destination building level that the moving object (101) hopes to reach, i.e., the destination location. Using FIG. 1 as an example of a building environment, embodiments of a method implemented by a front-end device are described below.

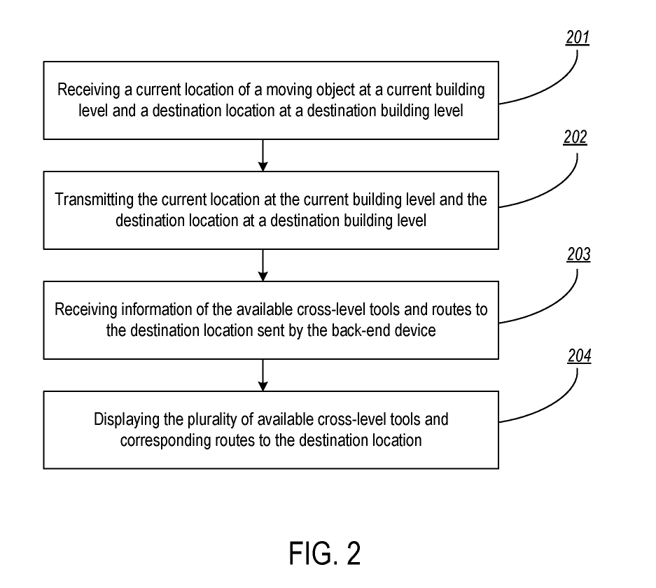

FIG. 2 is a flow diagram illustrating a method for indoor navigation according to some embodiments of the disclosure.

Step 201. The method receives, for example, by a front-end device, a current location of a moving object at a current building level and a destination location at a destination building level.

In one embodiment, the moving object comprises a user carrying an electronic device mentioned above (e.g., customers, security staff, shop assistants, etc.). Alternatively, or in conjunction with the foregoing, a moving object can comprise a robot, electric wheelchair, or a trackless vehicle integrated with the electronic device. Precise details on the type of a moving object are not specified herein and are not intended to limit the disclosed embodiments.

The front-end device can acquire the location information of the current building level received by an input device (e.g., manually from a user), as well as the location information of the current building level collected by a positioning device (e.g., a GPS device). For the location information of the destination building level, because the moving object has not arrived at the destination building level at this time point, the front-end device cannot acquire such information via location technology. Thus the front-end device may acquire the location information of the destination building level received by the input device. In one embodiment, the input device is located in a handheld device and the interaction may be performed via various input mechanisms such as images, sound, light, and vibration. The positioning device is also located in the electronic device for locating the indoor position of a moving object carrying the electronic device.

Regarding the location information of the current building level and the location information of the destination building level, the input device can directly receive the location information input by the moving object, or output the past locations visited or viewed by the moving object. The input device determines the location information selected therefrom by the moving object as the location information of the current building level or the location information of the destination building level.

With respect to the method for positioning, the positioning device can carry out indoor positioning through, but not limited to, the following technologies: Bluetooth (e.g., beacon-based positioning), Wi-Fi, and infrared ray positioning. For example, when using a Bluetooth beacon for positioning, a Bluetooth beacon positioning system can be deployed inside the building, i.e., installing Bluetooth base stations at a number of positions at each level inside the building. The positioning device scans signals transmitted from the base station according to the predetermined beacon interval, and the current position of the moving object can then be determined according to the SSID of the base station. Another example is as follows. When positioning with Wi-Fi positioning technology, a Wi-Fi positioning system can be deployed inside the building, i.e., installing signal transmitters of wireless routers at a number of positions at each level inside the building. Every corner inside the building will then be ensured to be covered by the range of the overlaid signal of the signal transmitters. Through receiving and superposition coding the Wi-Fi signals transmitted by different signal transmitters, the positioning device can acquire the specific position of the moving object. In addition to locating the horizontal two-dimensional coordinates of a moving object, the indoor positioning technology can also locate the specific vertical position of the moving object, which is different from conventional GPS positioning technology. For example, it can specifically determine on which floor the mobile device locates via receiving the signals transmitted by signal transmitters at different levels. Moreover, devices such as assistive devices with a magnetic field and sensors can also be used for indoor positioning in practical application. For example, light sensors can be provided at the designated areas such as the elevator exits and staircase corners. The electronic device can determine whether a moving object passes the designated area through the analog signals collected by the sensor, so as to acquire the current position of the moving object. The following embodiments of the disclosure will be illustrated using Wi-Fi positioning technology as an example. It should be made clear these descriptions are not intended to limit the positioning technology.

While conducting Wi-Fi positioning, only one unique device identification exists for each signal transmitter and the signal transmitter can transmit the device identification to the positioning device through Wi-Fi signals. In one embodiment, the positioning device is pre-loaded with a mapping relationship table showing the mapping between the device identification and the building levels. The building level where the moving object is located can be determined by looking up the device identification in the table. When the moving object enters into an indoor environment, the positioning device starts the locating process. The device determines the building level where the moving object is located as the current building level; then it further determines the planar position of the moving object at the current building level. As a result, the location information of the current building level will then be acquired.

After receiving the location information of the current building level, the front-end device initiates the process of deciding the location of the destination; and it determines the location information received by the input device as the location information of the destination building level. In practical application, the input device may remind the moving object to input the position coordinates or name of the destination building level through specific human-computer interface; or the input device may acquire the location of the destination building level input by the moving object through voice with speech recognition technology. If the moving object is a device, the electronic device can also receive, via a preset communication interface, the structured form of location information of the destination building level sent by the device. The present embodiment does not limit the acquisition manners of the electronic device used for receiving the location information of the destination building level. After receiving the location information of the destination building level, the front-end device extracts the information of the destination building level and the location information of the destination building level therefrom.

Optionally, in practical application, the location information of the starting building level may include the starting building level information only, without the plane position information of the moving object at the starting building level. Similarly, the location information of the destination building level may also only include the destination building level information. In this case, the indoor navigation only provides cross-level passage routes but not plane passage routes (e.g. the navigation route from a cross-level tool of the destination building level to the actual position at the destination building level). In the example shown in FIG. 1, the initial position of the moving object is located at the first level, and the location of the destination building level is located at the sixth level.

Step 202. Transmitting, to a back-end device, the current location at the current building level and the destination location at a destination building level.

The front-end device sends the above information to the back-end device, so that the back-end device can identify the multiple available cross-level tools and corresponding routes to the destination with such information. The cross-level tools referred here are cross-level tools that can directly or indirectly reach the destination building level from the current building level. Indirectly reaching the destination building level means to reach the destination building level by using other cross-level tools at the transfer building levels. The transfer building levels referred here are the building levels that the moving object passes in the process of reaching to the destination building level from the current building level. The routes to the destination refer to the passage routes that a moving object can take in order to reach the location of the destination building level using the available cross-level tools.

For example, the cross-level tools for the first level in FIG. 1 are elevators 1 to 3, escalators 1 to 3, and staircase 1. The moving object may directly reach the destination building level through elevator 1; the moving object may reach the second level or the third level through elevators 2 or 3 and then use elevator 1 to reach the destination building level; the moving object may reach the second level through escalators 1 to 3, then reach the destination building level by using elevator 1; or the moving object may use elevator 1 to reach the destination building level after reaching the third level through escalators 4 and 6; the moving object may also reach the destination building level by using the elevator 1 after reaching the second level through the stairway 1; or the moving object may reach the destination building level by using elevator 1 after reaching the third level through staircase 2. Among all the cross-level tools at the first level, the cross-level tool that can be used to go directly to the destination building level is elevator 1, and the cross-level tools that can be used to go indirectly to the destination building level are elevator 2, elevator 3, escalators 1 to 3, and staircase 1.

Clearly, all the cross-level tools at the first level can be used to go directly or indirectly to the destination building level; thus, the back-end device can determine any one of the multiple cross-level tools as available cross-level tool.

Then based on the available cross-level tools, the back-end device determines the routes to the destination. It is clear from FIG. 1 that each available cross-level tool has at least one corresponding route to the destination. For example, elevator 2 has two indirect routes to the sixth level, when other elevators are involved. The two routes are:

1. Reaching the sixth floor through elevator 1 after reaching the third level;

2. Reaching the sixth level through elevator 1 after reaching the fifth floor.

In some embodiments, one or multiple cross-level tools may exist on the current building level, and one or multiple corresponding routes to the destination may also exist for each available cross-level tool, which should not be limited by the illustrated embodiment. The back-end device can determine the recommended number of the available cross-level tools according to different recommendation strategies. For example, the back-end device can select available cross-level tools that are frequently-used by the moving object according to the statistics on the moving object's behavior and habits; or the back-end device may select the available cross-level tools relatively close to the moving object; or the back-end device may select the available cross-level tools with fewer users, higher load capacity, faster speed, or cross-level tools that are more convenient in use. In one embodiment, in order to maximize the range of options for the moving object, the back-end device can transmit all available cross-level tools and their corresponding routes to the destination to the front-end device for display; in order to simplify the description, in what follows the embodiment will be illustrated using ‘recommending all available cross-level tools’ as an example.

Step 203. Receiving information of the available cross-level tools and routes to the destination location sent by the back-end device.

The illustrated embodiment does not specify the adopted data format, observed communication protocol, communication timing (e.g. synchronization or asynchronization), and communication mode (e.g. simplex or duplex) between the front-end device and the back-end device.

Step 204. Displaying the plurality of available cross-level tools and corresponding routes to the destination location.

In this step, the front-end device may display information in the forms including, but not limited to, image, text and voice. Taking image display as an example.

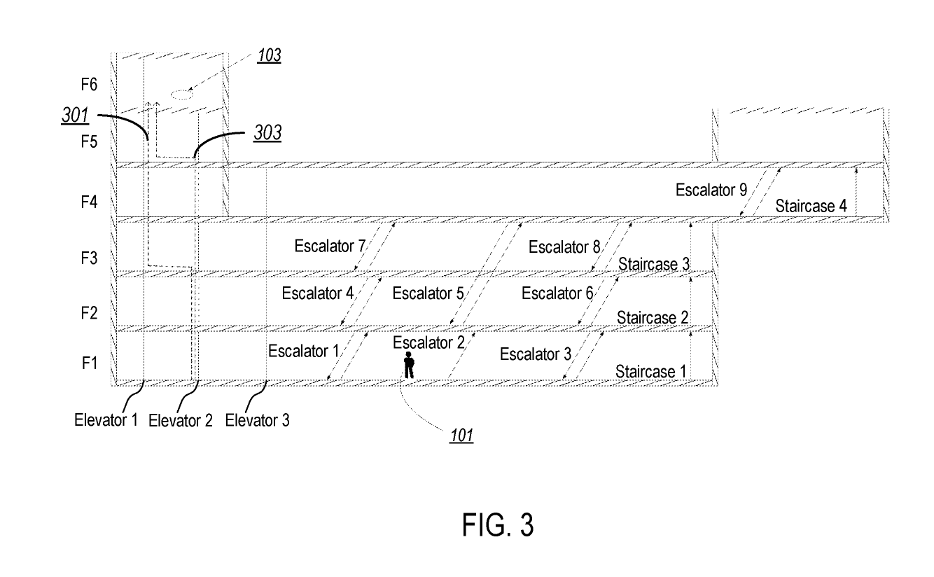

The front-end device displays the indoor map in the navigation interface of a navigation application, or on the web page of a browser as illustrated in FIG. 3. Elevator 2 is used as an example to illustrate the method of using the elevators only. All the corresponding routes (301, 303) to the destination for Elevator 2 labeled on the navigation map are shown in FIG. 3. In practical application, in accordance with the labeling for Elevator 2, the front-end device labels and displays the corresponding routes (301, 303) to the destination for elevators 1 to 3 on the indoor map respectively. If the used cross-level tool types are not specified, e.g., the moving object is not limited to using elevators only, the front-end device may label all available cross-level tools and their corresponding routes to the destination.

It should be noted that the labeling method shown in FIG. 3 is exemplary; in practical application, there is no limitation on the colors, transparency levels, or sizes of the labeling lines; or whether the line is dotted or solid; or whether the labeling lines are presented with a dynamic effect. Also, the available cross-level tools can be labeled with the forms including, but not limited to, arrows, highlighted boxes, and radiant points, etc.

Optionally, in one some embodiments, the front-end device can also determine the current location of a moving object in real time or periodically during the moving process. When it is determined that the moving object reaches a new building level that is not the destination building level, the steps shown in FIG. 2 above are repeated, and the navigation routes based on the new building level are then provided until the moving object reaches the destination building level.

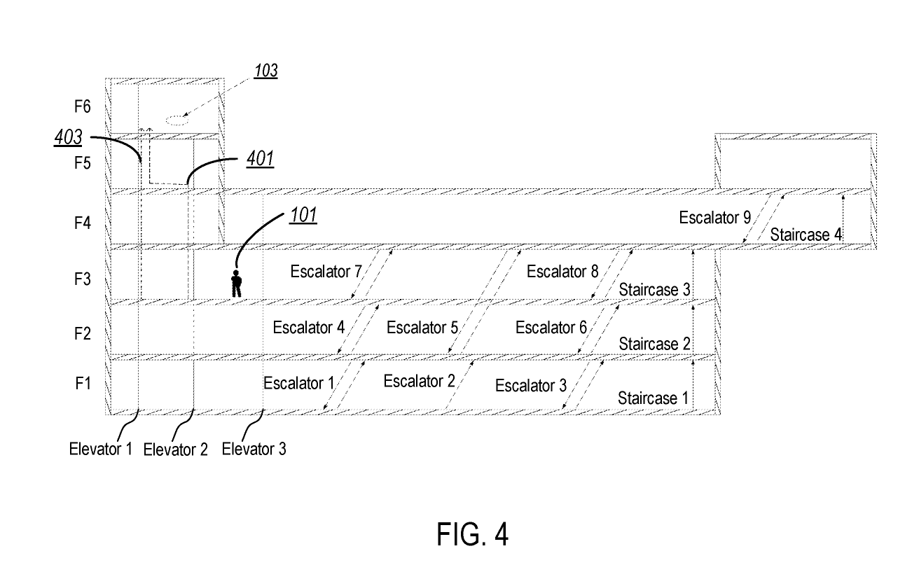

For example, the positioning device can locate the moving device in real time, such as continuously receiving Wi-Fi signals while locating without stopping; or it can locate the moving object periodically, such as performing the positioning regularly in accordance with preset time intervals. If a moving object is identified to have reached a new building level, as illustrated in FIG. 4, the front-end device will determine whether the new building level is the destination building level. If the result is positive, the process shown in FIG. 2 is terminated and the information that the navigation ends is output; otherwise, the new building level is taken as the current building level and steps 201 through step 204 are repeated; then all the available cross-level tools of the new building level and their corresponding routes (e.g., 401, 403) to the destination location (103) are displayed, until the moving object (101) reaches the destination location (103). For example, when a moving object (101) reaches the third level, and in the case that only elevators are selected for use, then the labeling method is shown in FIG. 4.

During the cross-level moving of a moving object, the method mentioned above can continuously re-plan the available cross-level tools and the corresponding routes to the destination based on the new building level where the moving object arrives at, achieving a navigation function that adjusts the routes dynamically. This design enables the moving objects to choose new routes based on the new levels they arrived at, and thereby further improve the varieties and flexibility of indoor navigation.

Based on the schematic diagram shown in FIG. 1, one embodiment of a method performed by the back-end device is provided below.

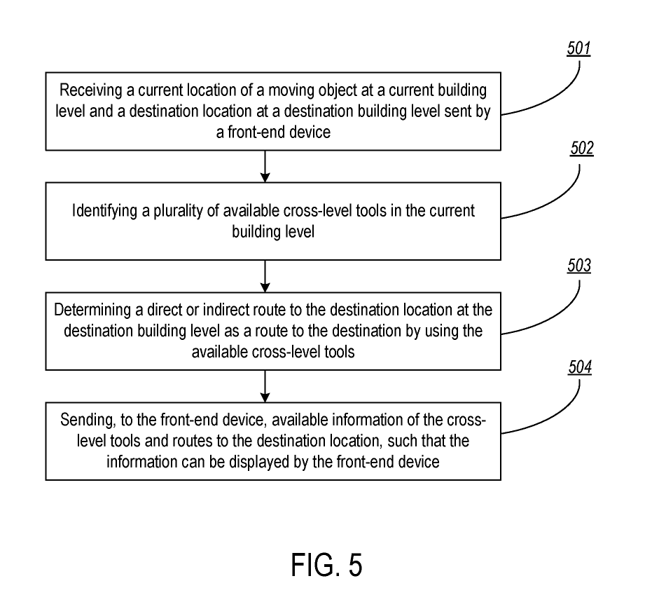

FIG. 5 is a flow diagram illustrating a method for indoor navigation according to some embodiments of the disclosure.

Step 501. Receiving a current location of a moving object at a current building level and a destination location at a destination building level sent by a front-end device. The back-end device receives the location of the current building level and the location of the destination building level transmitted by the front-end device through the step 202 shown in FIG. 2.

Step 502. Identifying a plurality of available cross-level tools in the current building level.

As mentioned above, the cross-level tools for the first level in FIG. 1 are Elevators 1 to 3, Escalators 1 to 3, and Staircase 1. The back-end device determines that the cross-level tool that can be used to go directly to the destination building level is Elevator 1, and the cross-level tools that can be used to go indirectly to the destination building level are Elevator 2, Elevator 3, Escalators 1 to 3, and Staircase 1.

Step 503. Determining a direct or indirect route to the destination location at the destination building level as a route to the destination by using the available cross-level tools;

The back-end device determines the corresponding routes to the destination based on each available cross-level tool. In practical application, one available cross-level tool has at least one corresponding route to the destination. For example, elevator 2 has two indirect routes to the destination, sixth level, when other elevators are involved. The two routes are:

1. Reaching the sixth floor through elevator 1 after reaching the third level;

2. Reaching the sixth level through elevator 1 after reaching the fifth floor.

Step 504. Sending, to the front-end device, available information of the cross-level tools and routes to the destination location, such that the information can be displayed by the front-end device.

Optionally, in one embodiment, the front-end device can also determine the current location of a moving object in real time or periodically during the moving process. When it is located that the moving object reaches a new building level that is not the destination building level, the back-end device repeats steps shown in FIG. 5 above, and the navigation routes based on the new building level are then provided until the moving object reaches the destination building level.

For example, when the front-end device re-acquires the location of current building level (the location of the destination building level may no longer need to be transmitted repeatedly), the back-end device may execute steps 501 through step 504 again, and search for all available cross-level tools of the new building level based on the new current location information of the building level and the location of the destination building level transmitted previously. Based on the available cross-level tools' direct or indirect routes that lead to the destination building level, the back-end device determines and transmits the newly identified available cross-level tools and routes to the destination again to the front-end device for labeling, until the moving object reaches the destination building level.

During the cross-level moving of a moving object, the method mentioned above can continuously re-plan the available cross-level tools and the corresponding routes to the destination based on the new building level where the moving object arrives at, achieving a navigation function that adjusts the routes dynamically. This design enables the moving objects to choose new routes based on the new levels they arrived at, and thereby further improving the varieties and flexibility of indoor navigation.

Furthermore, as a supplementation to the method shown in FIG. 2 and FIG. 5 above, the embodiment of the disclosure also provides a method for indoor navigation.

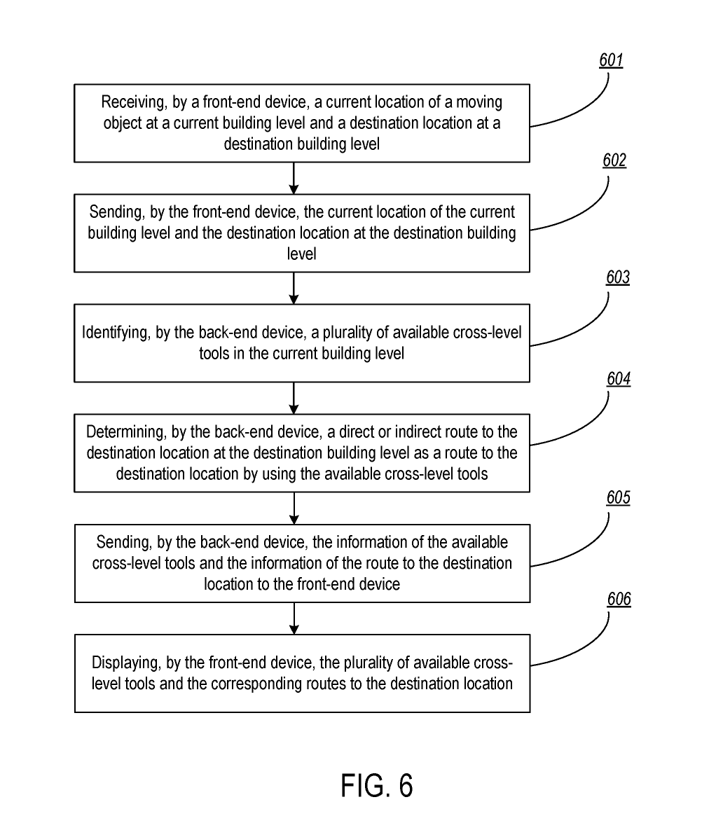

FIG. 6 is a flow diagram illustrating a method for indoor navigation according to some embodiments of the disclosure.

Step 601. Receiving, by a front-end device, a current location of a moving object at a current building level and a destination location at a destination building level.

In one embodiment, a complete route to the destination comprises two features: first, the navigation routes for horizontal movement on each building level; second, the vertical routes across the building levels.

Step 602. Sending, by the front-end device, the current location of the current building level and the destination location at the destination building level.

Step 603. Identifying, by the back-end device, a plurality of available cross-level tools in the current building level.

Step 604. Determining, by the back-end device, a direct or indirect route to the destination location at the destination building level as a route to the destination location by using the available cross-level tools.

After receiving the location of the current building level and the location of the destination building level, the back-end device traverses the direct or indirect routes to the location of the destination building level via the cross-level tools of the current building level based on a provided topological graph showing indoor passages or a relation table of building level passages. If such routes to the destination exist, the back-end device determines the cross-level tools as available cross-level tools.

The topological graph showing indoor passages and the relation table of building level passages are generated according to the configuration information of the building levels that the cross-level tools stop by. For example, the configuration information of elevator 1 is ‘the building levels to stop=F1, F2, F3, F4, F5, F6’; the configuration information of the escalator 2 is ‘the building levels to stop=F1, F2’. The topological graph showing indoor passages and the relation table of building level passages will then be generated according to the configuration information of all the cross-level tools. In practical application, the topological graph showing indoor passages and the relation table of building level passages are generated by back-end device exclusively or by other servers or devices, which are distributed to the back-end device for caching and updating regularly.

In one embodiment, the back-end device adopts the topological graph showing indoor passages to determine the available cross-level tools. The topological graph showing indoor passages, a topological network, provides all the passage relationships among all cross-level tools on all building levels and it exists as a data format in the back-end device. A visualized format of the topological graph is not necessarily required.

After determining all the cross-level tools on the current building level, the back-end device takes each cross-level tool as the starting point and runs a routing algorithm against the topological graph. The algorithm is used to traverse the routes to the destination building levels in the topological graph so that all the possible routes of the cross-level tools are gathered. It should be noted that some routes cannot reach the destination building level in the traversal in practical application. For example, the routes traversed through the escalators 3, 6, 8 and 9 sequentially cannot reach the destination building level in FIG. 1. The back-end device automatically deletes such routes.

In another embodiment, the back-end device adopts the relation table of building level passages to determine the available cross-level tools. The relation table of building level passages has a table data structure for recording the mapping relationships between the cross-level tools and their reachable building levels. Similar to the function of the topological graph, the relation table of building level passages shows all the passage relationships among all cross-level tools on all the building levels too. The corresponding routes to the destination of the cross-level tools can be obtained through traversing the table data and the route calculation.

After the route calculation for all the cross-level tools of the current building level is done, the mapping relationship between the cross-level tools and the routes to the destination can be obtained. Any cross-level tools that are found with “0” routes to the destination will be deleted by the back-end device.

Furthermore, the back-end device of this embodiment is able to identify the optimal route to the destination from all the found routes, and send the information to the front-end device for labeling. The optimal route is the route having the lowest building level transfer frequency or the shortest route distance. Usually, the complexity of various routes is different; for example, the transfer frequencies of the various routes are different, and so are the distances of the various routes. These factors influence the passing efficiency of the moving objects. To improve the passing efficiency of the moving objects, this embodiment filters the routes and identifies the optimal route and then recommends the selection to the moving object. Specifically, the back-end device gathers statistics of the transfer frequencies of each route. The transfer frequency is the number of the building levels where different cross-level tools are used. Such statistics may be obtained by using the aforementioned topological graph showing indoor passages and the relation table of building level passages. After the statistics have been compiled, the back-end device is able to identify the route having the lowest transfer frequency as the optimal route.

Alternatively, the back-end device gathers statistics of the route distance of each route. The route distance can be shown as S=H+X, wherein H is the distance of the cross-level in the vertical direction and X is the horizontal moving distance of a moving object on the building level. In the case where no traveling upstairs and downstairs is involved, no matter which route to the destination is adopted for navigation, the current building level and the destination building level remain unchanged, i.e., the vertical distance H of each route is the same. Therefore, in practical application, the horizontal moving distance X may represent the route distance S.

The horizontal moving distance X can be shown as X=A+B+C, wherein A is the distance from the location of the current building level to the location of the cross-level tool of the current building level, i.e., the horizontal moving distance of the moving object on the current building level; B is the distance from the previous cross-level tool to the upcoming cross-level tool on the transfer building level, i.e., the horizontal moving distance of the moving object on the transfer building level; C is the distance from the cross-level tool of the destination level to the desired location of the destination building level, i.e., the horizontal moving distance of the moving object on the destination building level. The back-end device calculates the horizontal moving distances of A, B, and C, which give rises to the horizontal moving distance X, the sum of A, B, and C.

In addition, the passing efficiency depends on the following: the number of cross-level tools used; the number of cross-level tool types used; the waiting times for each cross-level tool used; and finally the comfort levels of the cross-level tools used. Thus, other than the transfer frequencies and the route distances, the back-end device may further determine the optimal route according to the conditions of the above aspects. In practical application, the back-end device may consider only one condition of the above aspects or a combination of them, which should not be limited by this embodiment.

In identifying the optimal route, the back-end device can identify one optimal route to the destination for each respective, available cross-level tool; or the back-end device can identify one optimal route to the destination for each respective type of cross-level tools; or the back-end device can identify one optimal route to the destination from all the routes of the available cross-level tools. In practical application, however, the number of the routes to the destination may not be unique. For example, with respect to the different scopes of cross-level tools, the back-end device is able to come up with the top N optimal routes, wherein N is any positive integer greater than 1.

In this embodiment, to provide more possible routes for the moving objects, the back-end device can re-filter the non-optimal routes according to certain rules so that more routes to the destination are kept. Thus, in addition to the optimal route, the back-end device can further identify, from the non-optimal routes, the non-optimal routes without the loop structure; and the back-end device sends the non-optimal routes without the loop structure as the routes to the destination to the front-end device. The loop structure is a back-and-forth route between two building levels.

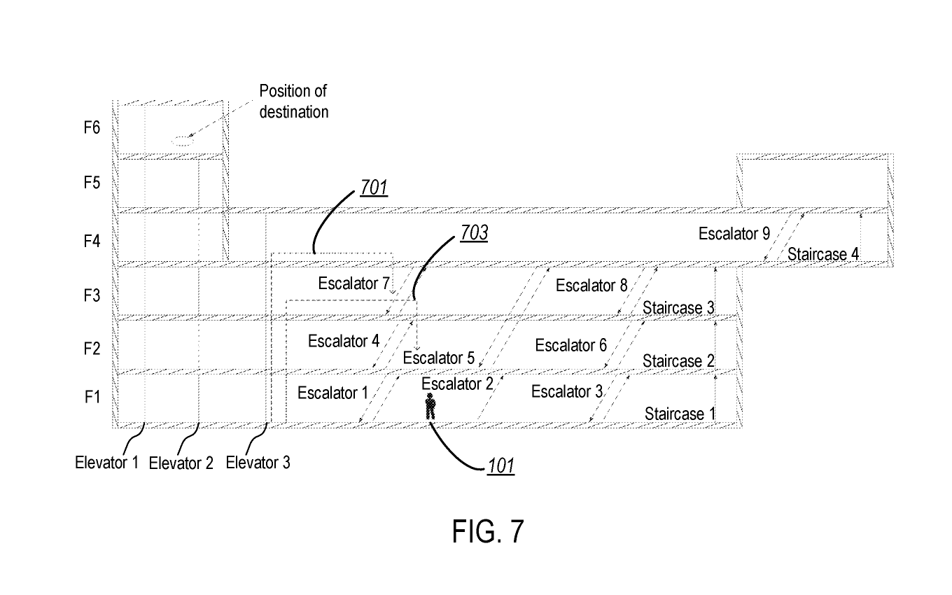

The configuration principle of the above rule can be that the route is reasonably planned, and no detours are included in the route to the destination. For example, in one embodiment, the rule complying with the above principle can be the route not including any loop structures. The so-called loop structure is a back-and-forth route between two building levels. For example, for the route to the destination as shown in FIG. 7, elevator 3 is used to reach level four, followed by escalator 7 being used to return to level three (indicated as route 701); or escalators 1 and 4 are used to reach level three and escalator 4 is then used to return to level two (indicated as route 703). These back-and-forth routes between two building levels that carry a loop structure that lowers the passing efficiency. A route planning that comes up with a route having a loop structure is considered not reasonably planned.

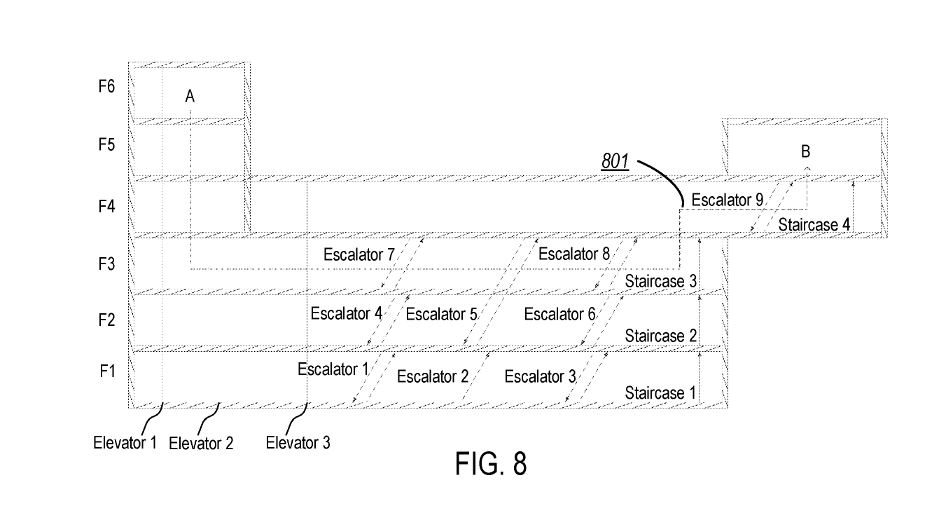

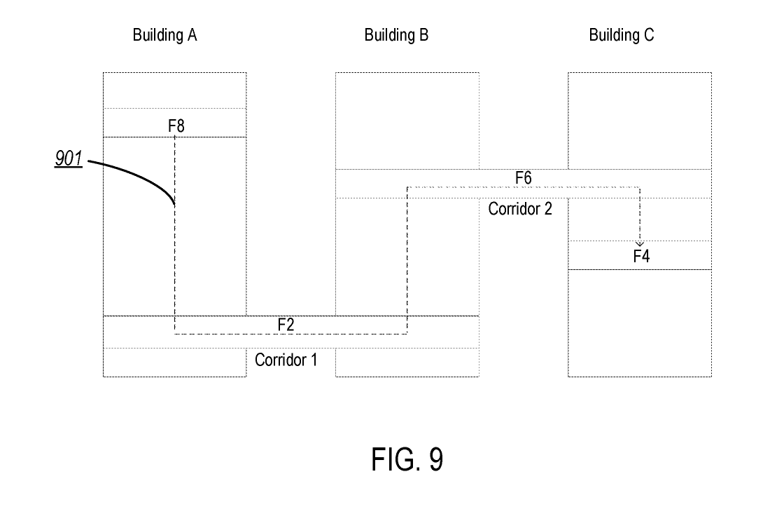

Nevertheless, it should be noted that not all the back-and-forth routes between two building levels are unreasonably-planned routes. An example is provided in FIG. 8. When a movement from location A on level six to location B on level five is needed, one back and forth traveling between level five and level four is required, as well as the back and forth traveling between level four and level three. This route is indicated as route (801) in FIG. 8. This kind of traveling back and forth is inevitable. Another example is shown in FIG. 9. In the case of the joined buildings, Building A and Building B are connected by corridor 1 on level two; and Building B is connected with Building C via corridor 2 on level six. An inevitable back and forth traveling (indicated as route 901) occurs when a need of reaching level four of Building C from level eight of Building A arises.

Thus, the following principles may be used to decide whether a route is reasonable or not: when meaningless and unnecessary back and forth routes exist in the routes, it is determined that the routes to the destinations include the loop structures and such routes are planned unreasonably. In this embodiment, the above principles may be quantified by using the following method so as to meet the executable standard of the back-end device. Specifically:

Step 1. The back-end device obtains the turn-back mode of the building levels of the non-optimal route.

The turn-back mode of the building levels is used to represent a route direction relationship between the building levels in the route to the destination; the back-end device generates and caches the turn-back mode of the building levels information in the traversal of routes. The so-called route direction relationship is a vector relationship showing the direction from the former arrival building level to the next arrival building level. For example, when an elevator is used to travel from level four to level six, and then an escalator is used to travel from level six to level seven, the route direction relationships are ‘4→6’ and ‘6→7’. Typically, one route may include several transfer building levels; generally speaking, the route direction relationships provided to the back-end device is thus a relationship collection. For example, the collections of the route direction relationships in FIG. 8 are ‘8→2’, ‘2→6’, and ‘6→4’.

Step 2. It is determined that the non-optimal route does not include a loop structure if the turn-back mode of the building levels does not include a route direction relationship indicating that any two building levels are connected.

The so-called route direction relationship in which two building levels lead to each other are cases when ‘A→B’ and ‘B→A’ are present in the collection of the route direction relationships, i.e., a route direction relationship in which building level A and building level B leading to each other is present. In this case, a meaningless back and forth traveling between the building levels A and B occurs, and thus a loop structure is present in the route to the destination.

It is clear from the collection of the route direction relationships of ‘8→2’, ‘2→6’ and ‘6→₄’ that the beginning and ending of the building levels of each adjacent route direction relationship are the same; that is, the whole route direction relationship is one-way and no direction relationship in which two building levels pointing to each is present. Thus, though a back and forth traveling exists in this route, a loop structure is not present, suggesting such a back and forth traveling in this case is necessary.

After obtaining the collection of the route direction relationships, the back-end device is able to traverse the building level number in the route direction relationships according to the sequence of the route direction relationships. A loop structure exists if the beginning and the ending building levels are swapped in a pair of route direction relationships; and a loop structure does not exist if any adjacent route direction relationship can meet the condition that the ending building level number in the former route direction relationship is the same as the beginning building level number in the latter route direction relationship.

It should be noted that in this embodiment, the route direction relationship should be defined by using the transfer building level as the endpoint rather than the sequence for passing the building levels, otherwise a misjudgment could occur. For example, the collections of the route direction relationships defined by the transfer building level as the endpoint in FIG. 8 are: ‘6→3’, ‘3→4’ and ‘4→5’. The collection of the route direction relationships defined by the sequence for passing the building levels, however, are ‘6→5’, ‘5→4’, ‘4→3’, ‘3→4’, and ‘4→5’. It is thus clear that the situations of (‘4→3’ and ‘3→4’) and (‘5→4’ and ‘4→5’) of the route direction relationships in which two building levels lead to each other may occur if the latter definition method is adopted and the route to the destination may be determined as having the loop. However, such back and forth traveling in the route is necessary according to FIG. 8 and the above judgment is obviously wrong.

Furthermore, one embodiment also provides an alternative to Step 2 mentioned above. In this alternative, the back-end device may previously store the turn-back mode of the building levels of a provided route model, which can be previously obtained by traversing the routes in the topological graph showing indoor passages and the relation table of building level passages; and a loop can be determined as not present via Step 2. After the execution of Step 1, the back-end device compares the turn-back mode of the building levels of the non-optimal route with that of a provided route model; it is determined that the non-optimal route does not include a loop structure if the turn-back mode of the building levels of the non-optimal route is the same as that of the provided route model. This alternative solution, when compared with Step 2, only requires verifying the data consistency of the turn-back modes of two building levels, without the need to traverse the routes in the direction relationship collection. Thus, the alternative solution takes less time and is more applicable to actual navigation scenarios.

In practical application, the back-end device can also adopt other provided route models. For example, statistics are gathered with respect to the route selections of the moving object, and the frequently selected route to the destination during the navigation by the moving object is determined as the provided route model. The theoretical basis for this implementation is that the moving object does not select a route including a loop structure assuming that the moving object is rational.

It should be noted that the judgment as to whether a loop structure is included is not required with respect to the optimal route to the destination. This is because that the mechanism of selecting the optimal route itself has determined that the optimal route does not include a loop structure. Taking the mechanism of selecting the shortest route distance as an example. The indoor structure design will necessarily ensure that at least one loop-free route between any building levels exists in practice (a staircase should be available in extreme cases); or it can be understood that ‘not all routes to the destinations have a loop structure’ is ensured. As the loop structure involves unnecessary route returning, the route distance of the route having the loop structure is by no means the shortest of all the routes to the destinations. This is especially the case when the route having the loop structure is compared with the loop-free route. Therefore, when an optimal route with the shortest route distance is identified, it certainly does not include the loop structure.

Step 605. Sending, by the back-end device, the information of the available cross-level tools and the information of the route to the destination location to the front-end device.

Step 606. Displaying, by the front-end device, the plurality of available cross-level tools and the corresponding routes to the destination location.

In this embodiment, the route to the destination includes an optimal route and a non-optimal route to the destinations that does not include the loop structure. When an image format is adopted for displaying, the front-end device can display the differences of the two routes via color, transparency, and line thicknesses. Certainly, a unified display is also a possible option.

Additionally, a complete route including a horizontal moving route can also be labeled in the process of labeling the route in order to improve the practicality of indoor navigation. As a result, the navigation function of ‘level to level’ is upgraded to ‘point to point’.

Furthermore, as a combination of the methods as shown in FIG. 2, 5, or 6, routes can also be recommended based on the needs of the moving object. Specifically, the back-end device can select, from the available cross-level tools corresponding to all routes to the destination, the available cross-level tool closest to the moving object. The front-end device displays the available cross-level tool closest to the moving object and the corresponding route to the destination. Specifically, the method may perform the following steps:

Step 1. Determining, by the back-end device, the available cross-level tool closest to the moving object.

The back-end device can identify the available cross-level tool closest to the current building level or determine the closest available cross-level tool on the basis of the selection of the moving object. For the latter method, the front-end device receives the information of the cross-level tool which the moving object requests to inquire by virtue of an input device first; and the front-end device sends the information of the cross-level tool which the moving object requests to inquire to the back-end device. The back-end device then determines whether the cross-level tool which the moving object requests is an available cross-level tool. If so, the back-end device determines the available cross-level tool as the available cross-level tool closest to the moving object.

Step 2. Sending, by the back-end device, tool information of the available cross-level tool closest to the moving object and the information of corresponding route to the destination to the front-end device.

Step 3. Displaying, by the front-end device, the available cross-level tool closest to the moving object and the corresponding route to the destination.

In practical application, the recommended available cross-level tool may be changed in accordance with the continuously-changing positions of the moving object in the former method. For the latter implementation method, when the moving object has a specific tool selection requirement, its application value focuses more on the inquiring process; that is, the moving object wants to use a specific cross-level tool (such as a cross-level escalator from building level one to building level six) but does not know the exact location of the cross-level tool. At this moment, the moving object can initiate the inquiry request by means of a keyword inquiry; and after the cross-level tool is identified by the back-end device, the front-end device displays the navigation route that leads to the cross-level tool.

Furthermore, for the implementation of the above method, the embodiment of the disclosure also provides an apparatus for indoor navigation. The apparatus is located in an electronic device and establishes a coupling relationship or a communication relationship with a back-end device for fulfilling the function of the front-end device in FIG. 2 or 6.

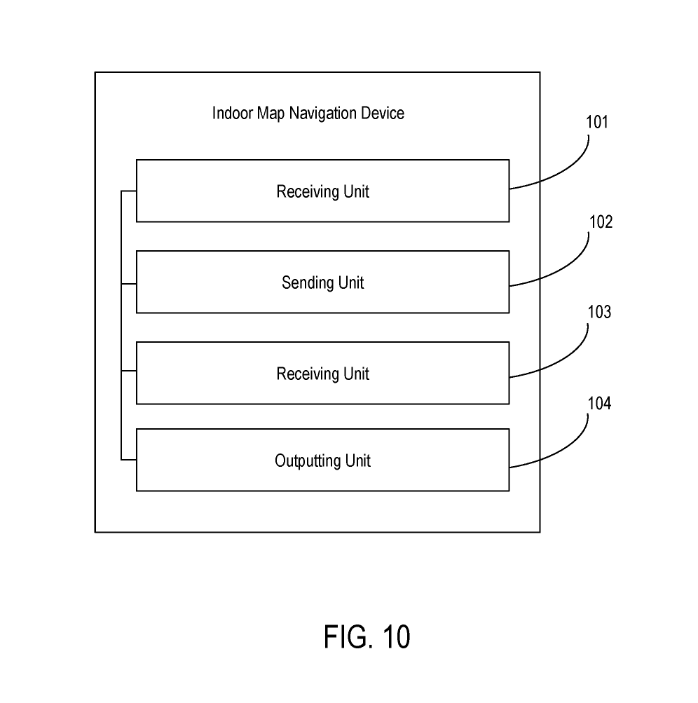

FIG. 10 is a block diagram illustrating an apparatus for indoor navigation according to some embodiments of the disclosure. As shown in FIG. 10, the apparatus comprises a receiving unit 101, a sending unit 102, a receiving unit 103, and an outputting unit 104.

The receiving unit 101 receives a location of a moving object at a current building level and a location of a destination building level.

The sending unit 102 sends, to a back-end device, the location of the current building level and the location of the destination building level.

The receiving unit 103 receives information of available cross-level tools and information of a route to a destination sent by the back-end device, wherein the available cross-level tools are a plurality of available cross-level tools of the current building level, and the route to the destination is a direct or indirect route to the location of the destination building level using the available cross-level tools.

The outputting unit 104 displays the plurality of available cross-level tools and the corresponding routes to the destination.

Furthermore, the receiving unit 101 receives location information of the current building level acquired by an input device; receives the location information of the current building level collected by a positioning device; and receives the location information of the destination building level acquired by the input device.

Furthermore, the route to the destination received by the receiving unit 103 is an optimal route having the lowest building level transfer frequency or the shortest route distance.

Furthermore, the route to the destination received by the receiving unit 103 is a non-optimal route without a loop structure.

Furthermore, the receiving unit 103 receives tool information of the available cross-level tools closest to the moving object and route information of the corresponding route to the destination sent by the back-end device.

The outputting unit 104 displays the available cross-level tool closest to the moving object and the corresponding route to the destination.

Furthermore, the receiving unit 101, prior to receiving tool information of the available cross-level tools closest to the moving object and route information of the corresponding route to the destination sent by the back-end device, receiving cross-level tool information the moving object requests to inquire via the input device.

The sending unit 102 sends, to the back-end device, the cross-level tool information the moving object requests to inquire, so that the back-end device returns the routes information of the destination corresponding to the cross-level tool information.

Furthermore, in one embodiment, a positioning device can position the moving object in a real-time or periodic manner. When new positioning data is generated, each unit in the device shown in FIG. 10 restarts its functions described above and re-labels the available cross-level tools and the routes to the destination based on the new building level where the moving object arrives at.

Additionally, as an implementation of the above method, the embodiment of the disclosure also provides an apparatus for indoor navigation. The apparatus is located in an electronic device and establishes a coupling relationship with the front-end device, or is located at a network side and establishes a communication relationship with the front-end device for realizing the functions of the back-end device in FIG. 5 or 6.

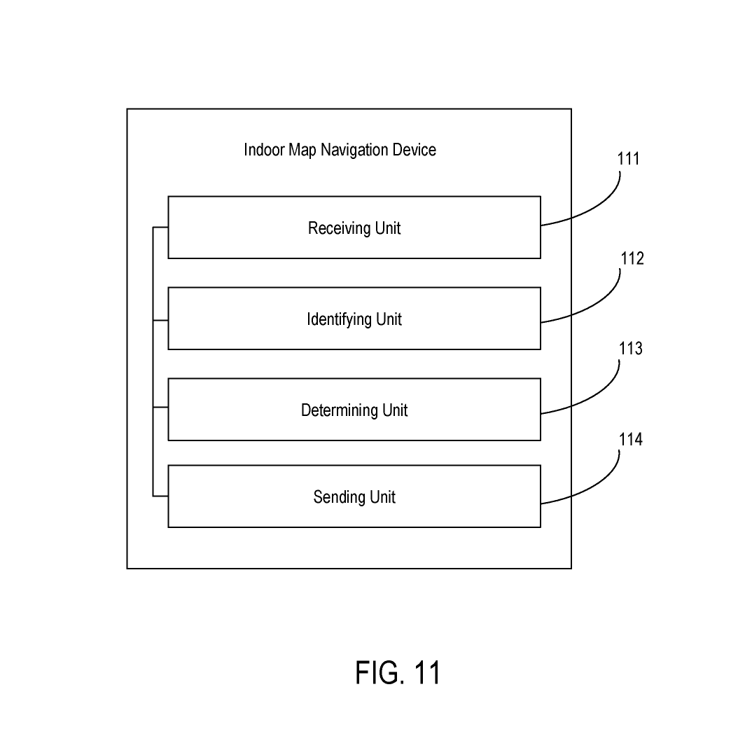

FIG. 11 is a block diagram illustrating an apparatus for indoor navigation according to some embodiments of the disclosure. As shown in FIG. 11, the apparatus comprises an receiving unit 111, an identifying unit 112, a determining unit 113 and a sending unit 114.

The receiving unit 111 receives a location of a moving object at a current building level and a location of a moving object at a destination building level sent by a front-end device.

The identifying unit 112 identifies a plurality of available cross-level tools in the current building level.

The determining unit 113 determines a direct or indirect route to the location of the destination building level as a route to the destination by using the available cross-level tools.

The sending unit 114 sends, to the front-end device, the information of the available cross-level tools and the routes information of the destinations, so that such information can be displayed by the front-end device.

Furthermore, the identifying unit 112 traverses the direct or indirect routes to the location of the destination building level via the cross-level tools of the current building level based on a provided topological graph showing indoor passages or a relation table of building level passages, wherein the provided topological graph showing indoor passages and the relation table of building level passages are generated according to the configuration information of the building levels where the cross-level tools visited and stopped. If the route to the destination exists, the identifying unit 112 determines the cross-level tools as the available cross-level tools.

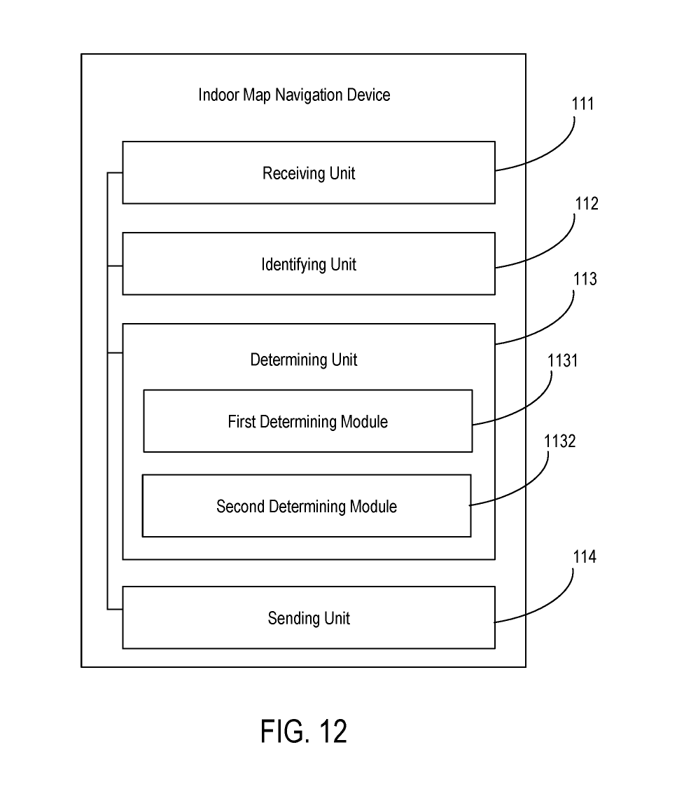

FIG. 12 is a block diagram illustrating an apparatus for indoor navigation according to some embodiments of the disclosure.

As shown in FIG. 12, the determining unit 113 comprises a first determining module 1131, used for identifying the optimal route from the routes to the destination, wherein the optimal route is the route having the lowest building level transfer frequency or the shortest route distance; and determining the optimal route as the route to the destination.

Furthermore, as shown in FIG. 12, the determining unit 113 comprises a second determining module 1132, used for identifying a non-optimal route without a loop structure in the non-optimal routes, wherein the loop structure is a back-and-forth route between two building levels; and determining the non-optimal route without the loop structure as the route to the destination.

Additionally, the second determining module 1132 is used for receiving a turn-back mode of the building levels of the non-optimal routes, wherein the turn-back mode of the building levels is used to represent a route direction relationship between the building levels in the route to the destination; and determining that the non-optimal route does not include a loop structure if the turn-back mode of the building levels does not include a route direction relationship indicating that any two building levels are connected.

The second determining module 1132 is further used for comparing the turn-back mode of the building levels of the non-optimal route with that of a provided route model, wherein the provided route model does not include a loop structure; and determining that the non-optimal route does not include a loop structure if the turn-back mode of the building levels of the non-optimal route is the same as that of the provided route model.

Furthermore, the identifying unit 112 determines the available cross-level tool closest to the moving object.

The sending unit 114 sends, to the front-end device, tool information of the cross-level tool closest to the moving object and information of corresponding route to the destination, so that such information can be displayed by the front-end device.

Furthermore, the identifying unit 112 identifies the available cross-level tool closest to the current building level; and receiving the cross-level tool information, which the moving object requests to inquire, sent from the front-end device; and if the cross-level tool the moving object requests to inquire is an available cross-level tool, then determining the available cross-level tool as the available cross-level tool closest to the moving object.

Furthermore, in one implementation of the embodiment, a positioning device in the electronic device can position the moving object in a real-time or periodic manner. When new positioning data is generated, each unit in the device shown in FIG. 11 or 12 restarts its functions described above and re-identify and re-determine the available cross-level tools and the routes to the destination based on the new building level where the moving object arrives at.

Furthermore, as an implementation of the above method, the embodiment of the disclosure also provides a system for indoor navigation.

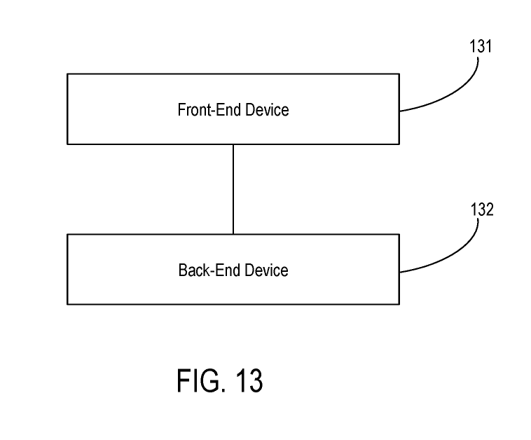

FIG. 13 is a schematic diagram of a system for indoor navigation according to some embodiments of the disclosure. As shown in FIG. 13, the system comprises a front-end device 131 and a back-end device 132. The front-end device 131 can be a device shown in FIG. 10 and the back-end device 132 can be a device shown in FIG. 11 or 12.

Furthermore, both the front-end device 131 and the back-end device 132 are positioned in an electronic device, and a coupling relationship exists between the front-end device 131 and the back-end device 132.

Additionally, the front-end device 131 is located in an electronic device and the back-end device 132 is located at a network side; a communication path exists between the front-end device 131 and the back-end device 132.

According to the apparatus and system for indoor navigation provided by the embodiments of the disclosure, the front-end device displays a plurality of available cross-level tools of the building level where the moving object is located and the corresponding routes to the destinations, offering the moving object options to choose. According to the embodiments of the disclosure, when a moving object moves among different levels, like going up and down the stairs, one can fully use the options of various feasible passage routes gathered based on the arrangements and combinations of the different cross-level tools of each building level. Compared with the one and only fixed route recommended as in the prior art, the embodiments of the disclosure provide expanded selections of passage routes and improve indoor navigation flexibility, thereby assisting the customers to arrive at their destinations in a faster manner.

Additionally, during the cross-level moving of a moving object, the indoor navigation apparatus and system provided by the embodiments of the disclosure can continuously re-plan the available cross-level tools and the corresponding routes to the destination based on the new building level where the moving object arrives at, achieving a navigation function that adjusts the routes dynamically. This design enables the moving objects to choose new routes based on the new levels they arrived at, and thereby further improving the varieties and flexibility of indoor navigation.

In the embodiments, the description of each embodiment has its own focus, and parts in a certain embodiment which are not described in detail can refer to the related descriptions of the other embodiments.

It can be understood that the relevant features of the method and apparatus described above can be mutually referred to. In addition, words like ‘first’, ‘second’ and the like in the above embodiments are used to distinguish the embodiments and do not represent the superiority or inferiority of the embodiments.

Those skilled in the art can clearly understand that for convenient and simple description, the specific working processes of the systems, the device and the units described above can refer to the corresponding processes in the foregoing method embodiments, and are not repeated here.

The algorithms and displays provided herein are not inherently related to any particular computer, virtual system or other devices. Various general systems may also be used with the teaching based on the disclosure herein. According to the above description, the required structure for constructing such a system is obvious In addition, the disclosure is not directed to any particular programming language. It should be understood that the content of the disclosure described herein can be implemented with a variety of programming languages, and the foregoing description to a particular language is for the purpose of disclosing the optimum embodiments of the disclosure.

Many specific details are given in the Specification provided herein. It shall be understood, however, that embodiments of the disclosure can be implemented without these specific details. In some embodiments, well-known methods, structures, and techniques have not been shown in detail to avoid an unclear understanding of the Specification.

Similarly, it is to be understood that, in order to simplify the disclosure and to facilitate the understanding of one or more of the various inventive aspects, various features of the disclosure are sometimes grouped together into a single embodiment, figure, or a description thereof in the above description of the exemplary embodiments of the disclosure. However, the disclosed method should not be construed as to reflect the following intention: the disclosure for which the protection is sought claims more features than those explicitly disclosed in each of claims. More specifically, as reflected in the following claims, the inventive aspect is in that the features therein are less than all features of a single embodiment as disclosed above. Therefore, the claims following the detailed description are hereby expressly incorporated into the detailed description, with each claim standing on its own as a separate embodiment of the disclosure.

Those skilled in the art should appreciate that the modules in the device of the embodiments can be self-adaptively changed and arranged in one or more devices which are different from the embodiment. The modules or units or components in the embodiments can be combined into one module or unit or component, and furthermore they can be divided into a plurality of sub-modules or sub-units or sub-components. Except for the cases in which certain features and/or processes and/or units are mutually exclusive, all of the features disclosed in this Specification (including accompanying claims, abstract, and drawings) and any process or unit of any method or device disclosed can be combined in any manner. Unless otherwise expressly stated, each feature disclosed in this Specification (including accompanying claims, abstract, and drawings) can be replaced by alternative features that can achieve the same, equivalent, or similar purpose.

In addition, it should be understood by those skilled in the art that although some embodiments as discussed herein comprise some features included in other embodiment rather than other features, combination of features in different embodiment means that the combination is within the scope of the disclosure and forms different embodiments. For example, in the following claims, any one of the claimed embodiments can be used in any combination.

The various component embodiments of the disclosure can be implemented in terms of hardware, or software module operating on one or more processors, or a combination thereof. Those skilled in the art should understand that, in practice, some or all functions of some or all components on the basis of the subject (e.g., device for determining the link level within a website) of the embodiments of the disclosure can be implemented in practice by using a microprocessor or a digital signal processor (DSP). The disclosure can also be implemented as a device or device program (e.g., a computer program and a computer program product) for performing a part or all of the methods described herein. Such programs implementing the disclosure can be stored on a computer-readable medium or in one or more signal forms. Such signal can be downloaded from the Internet website, provided on the carrier signal, or provided in any other forms.

It should be noted that the above-described embodiments are intended to illustrate the disclosure and not to limit the disclosure; and that those skilled in the art can devise alternative embodiments without departing from the scope of the appended claims. In the claims, any reference symbols placed between parentheses shall not be construed as to limit the claim. The word ‘include’ does not exclude the presence of elements or steps that are not listed in the claims. The word ‘one’ preceding an element does not exclude the presence of a plurality of such elements. The disclosure can be implemented by means of hardware including several distinct elements and a suitably-programmed computer. In the element claims enumerating several devices, several of these devices can be embodied by the same hardware. The use of the words first, second, and third does not denote any order. These words can be interpreted as names.

What is claimed is:

1. A method comprising:
receiving a current location of a moving object at a current building level and a destination location at a destination building level;
transmitting the current location and the destination location to a back-end device;
receiving information of available cross-level tools and routes to the destination location from the back-end device, the available cross-level tools comprising a plurality of available cross-level tools located at the current building level and the routes to the destination location comprising one or more direct or indirect routes to the destination location using the available cross-level tools; and
displaying the available cross-level tools and the routes to the destination location.

2. The method of claim 1, wherein the one or more direct or indirect routes includes an optimal route having a lowest building level transfer frequency or a shortest route distance and a non-optimal route without a loop structure.

3. The method of claim 1, further comprising:
receiving tool information of the available cross-level tools closest to the moving object and corresponding routes utilizing the available cross-level tools closest to the moving object;
recommending the available cross-level tool closest to the moving object and the corresponding routes to the destination.

4. The method of claim 1, wherein the current location of a moving object at a current building level is determined via Bluetooth, Wi-Fi, or infrared ray positioning.

5. The method of claim 1, further comprising identifying, at the back-end device, information of available cross-level tools and routes to the destination location from the back-end device, wherein identifying information of available cross-level tools and routes to the destination location comprises:
determining a set of direct or indirect routes to the destination location via the cross-level tools of the current building level based on a provided topological graph showing indoor building passages or a relation table of building level passages, wherein the provided topological graph showing indoor passages and the relation table of building level passages are generated according to configuration information of the building levels where the cross-level tools begin, stop, or end; and
identifying the cross-level tools of the route as the available cross-level tools if a route to the destination exists.

6. The method of claim 5, wherein determining a set of direct or indirect routes to the destination location comprises:
identifying the optimal route from the set of direct or indirect routes to the destination, wherein the optimal route is a route having a lowest building level transfer frequency or the shortest route distance; and
determining the optimal route as the route to the destination.

7. The method of claim 5, wherein determining a set of direct or indirect routes comprises:
identifying a non-optimal route without a loop structure in a set of non-optimal routes, wherein the loop structure is a back-and-forth route between two building levels; and
identifying the non-optimal route without the loop structure as the route to the destination.

8. The method of claim 7, wherein the identifying a non-optimal route without a loop structure in a set of non-optimal routes comprises:
receiving a turn-back mode of a plurality of building levels of the set of non-optimal routes, wherein the turn-back mode of the plurality of building levels represents a route direction relationship between the plurality of building levels in the route to the destination; and
determining that the non-optimal route does not include a loop structure if the turn-back mode of the building levels does not include a route direction relationship indicating that any two building levels are connected.

9. The method of claim 8, wherein the determining that the non-optimal route does not include a loop structure if the turn-back mode of the building levels does not include a route direction relationship indicating that any two building levels are connected comprises:
comparing the turn-back mode of the plurality of building levels of the non-optimal route with that of a provided route model, wherein the provided route model does not include a loop structure; and
determining that the non-optimal route does not include a loop structure if the turn-back mode of the plurality of building levels of the non-optimal route is the same as that of the provided route model.

10. The method of claim 1 further comprising:
transmitting a second location of a moving object at a second building level to a back-end device;
receiving information of available cross-level tools and routes to the destination location from the back-end device, wherein the available cross-level tools comprise a plurality of available cross-level tools at the second building level, and the routes to the destination location include one or more direct or indirect routes to the destination location using the available cross-level tools; and
displaying the available cross-level tools and the routes to the destination location

11. An apparatus comprising:
one or more processors; and
a non-transitory memory storing computer-executable instructions therein that, when executed by the processor, cause the apparatus to perform the operations of:
receiving a current location of a moving object at a current building level and a destination location at a destination building level;
transmitting the current location and the destination location to a back-end device;
receiving information of available cross-level tools and routes to the destination location from the back-end device, wherein the available cross-level tools comprise a plurality of available cross-level tools located at the current building level, and the routes to the destination location comprising one or more direct or indirect routes to the destination location using the available cross-level tools; and
displaying the available cross-level tools and the routes to the destination location.

12. A system comprising:
a front-end device for:
receiving a current location of a moving object at a current building level and a destination location at a destination building level,
receiving information of available cross-level tools and routes to the destination location, wherein the available cross-level tools comprise a plurality of available cross-level tools located at the current building level, and the routes to the destination location comprising one or more direct or indirect routes to the destination location using the available cross-level tools, and
displaying the available cross-level tools and the routes to the destination location; and
a back-end device for:
receiving the current location and the destination location from the front-end device,
identifying information of available cross-level tools and routes to the destination location, and
transmitting information of available cross-level tools and routes to the destination location to the front-end device.

13. The system of claim 12, wherein the one or more direct or indirect routes includes an optimal route having a lowest building level transfer frequency or a shortest route distance and a non-optimal route without a loop structure.

14. The system of claim 12, wherein the back-end device is further configured to:
receive tool information of the available cross-level tools closest to the moving object and corresponding routes utilizing the available cross-level tools closest to the moving object;
recommend the available cross-level tool closest to the moving object and the corresponding routes to the destination.

15. The system of claim 14, wherein the current location of a moving object at a current building level is determined via Bluetooth, Wi-Fi, or infrared ray positioning.

16. The system of claim 12, wherein identifying information of available cross-level tools and routes to the destination location from the back-end device comprises:
determining a set of direct or indirect routes to the destination location via the cross-level tools of the current building level based on a provided topological graph showing indoor building passages or a relation table of building level passages, wherein the provided topological graph showing indoor passages and the relation table of building level passages are generated according to configuration information of the building levels where the cross-level tools begin, stop, or end; and
identifying the cross-level tools of the route as the available cross-level tools if a route to the destination exists.

17. The system of claim 16, wherein the determining a set of direct or indirect routes to the destination location comprises:
identifying the optimal route from the set of direct or indirect routes to the destination, wherein the optimal route is a route having a lowest building level transfer frequency or the shortest route distance; and
determining the optimal route as the route to the destination.

18. The system of claim 16, wherein the determining a set of direct or indirect routes comprises:
identifying a non-optimal route without a loop structure in a set of non-optimal routes, wherein the loop structure is a back-and-forth route between two building levels; and
identifying the non-optimal route without the loop structure as the route to the destination.

19. The system of claim 18, wherein the identifying a non-optimal route without a loop structure in a set of non-optimal routes comprises:
receiving a turn-back mode of a plurality of building levels of the set of non-optimal routes, wherein the turn-back mode of the plurality of building levels represents a route direction relationship between the plurality of building levels in the route to the destination; and
determining that the non-optimal route does not include a loop structure if the turn-back mode of the building levels does not include a route direction relationship indicating that any two building levels are connected.

20. The system of claim 19, wherein the determining that the non-optimal route does not include a loop structure if the turn-back mode of the building levels does not include a route direction relationship indicating that any two building levels are connected comprises:
comparing the turn-back mode of the plurality of building levels of the non-optimal route with that of a provided route model, wherein the provided route model does not include a loop structure; and
determining that the non-optimal route does not include a loop structure if the turn-back mode of the plurality of building levels of the non-optimal route is the same as that of the provided route model.
